(19) United States
(12) Patent Application Publication
(10) Pub. No.: US 2023/0150260 A1
(43) Pub. Date: May 18, 2023

(54) LIQUID EJECTION APPARATUS AND CONTROL METHOD OF LIQUID EJECTION APPARATUS

(71) Applicant: CANON KABUSHIKI KAISHA, Tokyo (JP)

(72) Inventors: Rei Kurashima, Kanagawa (JP); Toru Nakakubo, Kanagawa (JP); Hiroyuki Ozaki, Kanagawa (JP)

(21) Appl. No.: 17/984,322

(22) Filed: Nov. 10, 2022

(30) Foreign Application Priority Data
Nov. 16, 2021 (JP) 2021-186526

(51) Int. Cl. B41J 2/045; B41J 2/175

(52) U.S. Cl. CPC B41J 2/04588; B41J 2/04541; B41J 2/17596; B41J 2/17523; B41J 2/17556

(57) ABSTRACT

A liquid ejection apparatus includes: an ejection unit that ejects from an ejection port a liquid in a pressure chamber communicating with the ejection port; a first flow channel that allows for communication between the pressure chamber and a liquid supply unit; a second flow channel communicating with the pressure chamber; a liquid transportation chamber communicating with a connection flow channel communicating with the first flow channel and the second flow channel; a liquid transportation unit that flows the liquid in the liquid transportation chamber in a predetermined direction by expanding and contracting the liquid transportation chamber with application of a driving voltage including a step-up waveform and a step-down waveform; and a control unit that performs control such that a liquid ejection timing does not coincide with a voltage application period in which one of the step-up and step-down waveforms that has a greater voltage change rate is applied.

### BACKGROUND OF THE INVENTION

### Field of the Invention

The present invention relates to a liquid ejection apparatus that ejects a liquid from an ejection port and a control method of the same.

### Description of the Related Art

Recent years, along with development in micromachine technology (MEMS technology), there has been proposed a liquid transportation device that transports liquid on the order of μms.

Japanese Patent Laid-Open No. 2003-286940 discloses a micropump that takes advantage of a flow channel resistance that is changed non-linearly with respect to a flow velocity and uses the action of fluid as a valve mechanism without using a mechanical valve structure. According to the micropump disclosed in Japanese Patent Laid-Open No. 2003-286940, it is possible to transport a liquid on the order of μms with a simple and small configuration including a few parts. Japanese Patent Laid-Open No. 2003-286940 discloses a driving method that allows the piezoelectric element to function as a pump by using a piezoelectric element in the form of membrane as a driving source and changing a voltage applied to the piezoelectric element asymmetrically against time.

In the liquid transportation device disclosed in Japanese Patent Laid-Open No. 2003-286940, the liquid is quantitatively transported by displacing the piezoelectric element and repeating an operation to rapidly expand (contract) the inner volume of a liquid transportation chamber and an operation to moderately contract (expand) the inner volume of the liquid transportation chamber. In a case where the liquid transportation device is used for a liquid transportation operation in a flow channel of a liquid ejection apparatus, a pressure variation that occurs due to the rapid change in the inner volume of the liquid transportation chamber may affect an ejection operation of a liquid droplet, and degradation in the ejection characteristics may be caused.

### SUMMARY OF THE INVENTION

The present invention is made in view of the above-described problems, and an object thereof is to provide a liquid ejection apparatus that is capable of suppressing an effect on an ejection operation of a liquid even in a case where the ejection operation of the liquid from an ejection port and a liquid transportation operation to a flow channel communicating with the ejection port are performed in parallel.

Further features of the present invention will become apparent from the following description of exemplary embodiments with reference to the attached drawings.

### BRIEF DESCRIPTION OF THE DRAWINGS

FIGS. 1A and 1B are diagrams illustrating an ink jet printing apparatus in the present embodiment;

FIG. 2 is a perspective view of a printing head used in the present embodiment;

FIGS. 3A and 3B are diagrams illustrating a flow channel configuration of one flow channel block in an element substrate;

FIGS. 4A to 4C are schematic views describing a structure and operations of a liquid transportation mechanism;

FIGS. 5A and 5B are diagrams illustrating a waveform of a driving voltage applied to a thin film piezoelectric element;

FIGS. 6A and 6B illustrate waveforms of two types of driving voltages applied to the thin film piezoelectric element;

FIGS. 7A to 7C are timing charts illustrating a driving sequence of ejection elements and pumps in a first embodiment;

FIGS. 8A to 8C are timing charts illustrating a driving sequence of the ejection elements and the pumps in a second embodiment;

FIGS. 9A to 9C are timing charts illustrating a driving sequence of the ejection elements and the pumps in a third embodiment;

FIGS. 10A and 10B are diagrams illustrating waveforms of the two types of the driving voltages applied to a piezoelectric element of the liquid transportation mechanism;

FIGS. 11A and 11B are diagrams illustrating flows of ink in two regions provided in the flow channel block;

FIGS. 12A to 12C are timing charts illustrating a driving sequence of the ejection elements and the pumps in a fourth embodiment;

FIGS. 13A to 13C are timing charts illustrating a driving sequence of the ejection elements and the pumps in a fifth embodiment;

FIGS. 14A to 14C are timing charts illustrating an example of a driving sequence of the ejection elements and the pumps in a sixth embodiment;

FIGS. 15A to 15C are timing charts illustrating another example of the driving sequences of the ejection elements and the pumps in the sixth embodiment; and

FIGS. 16A to 16C are timing charts illustrating a driving sequence of ejection element and pumps in a seventh embodiment.

### DESCRIPTION OF THE EMBODIMENTS

Embodiments of a liquid ejection apparatus according to the present invention are described below in detail with reference to the drawings. In the embodiments described below, as a liquid ejection apparatus ejecting a liquid, an ink jet printing apparatus in which a printing head ejecting ink is mounted is described as an example. The embodiments below are not intended to limit the present invention according to the scope of claims, and not all the combinations of the characteristics described in the present embodiments are necessarily required for the means for solving the problems of the present invention.

### First Embodiment

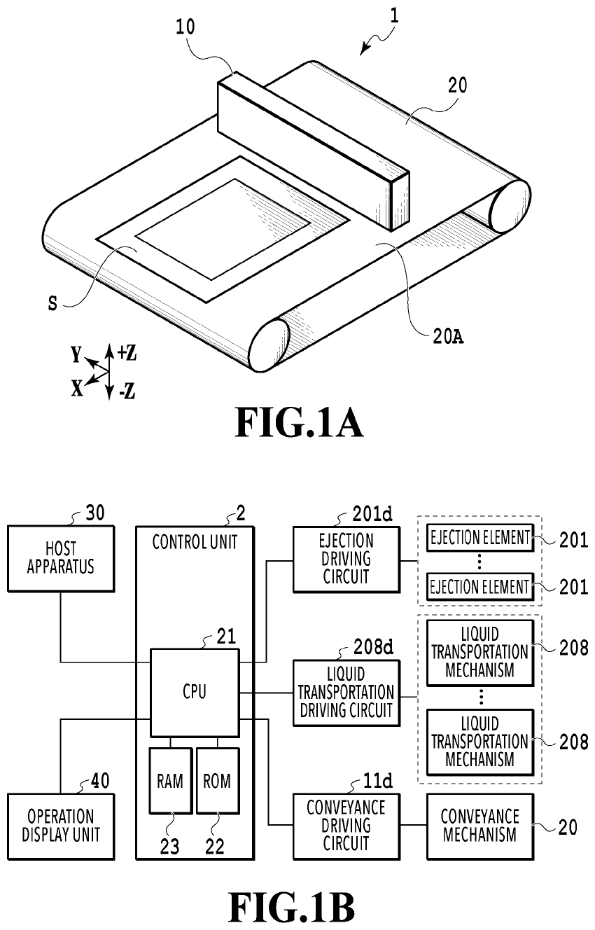

FIGS. 1A and 1B are diagrams illustrating an ink jet printing apparatus (hereinafter, simply referred to as a printing apparatus) 1 in the present embodiment. FIG. 1A is a perspective view illustrating a basic configuration, and FIG. 1B is a block diagram illustrating a schematic configuration of a control system of the printing apparatus 1. The printing apparatus 1 in the present embodiment is a so-called full line type printing apparatus and includes a conveyance mechanism 20 that conveys a printing medium S in an X direction, a printing head 10 capable of ejecting ink (liquid) from multiple ejection ports, and the control system illustrated in FIG. 1B. The conveyance mechanism 20 of the present embodiment conveys the printing medium S in the X direction by using a conveyance belt 20A that is moved by driving of a not-illustrated conveyance motor.

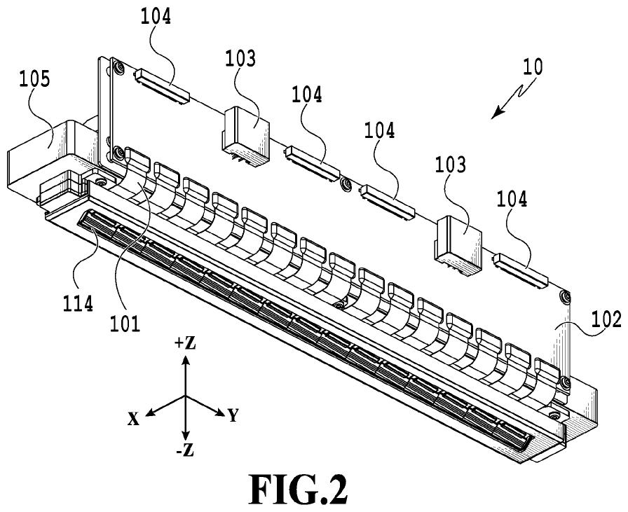

The printing head 10 is a full line type printing head extending in a Y direction crossing (in the present example, orthogonal to) the conveyance direction of the printing medium S (X direction). In the printing head 10, the multiple ejection ports capable of ejecting the ink are arrayed along the Y direction. The ejection ports may also be referred to as nozzles. A later-described circulation flow channel is formed inside the printing head 10. The ink is supplied to the circulation flow channel from an ink supply unit 105 (see FIG. 2), and the ink is supplied to the ejection ports communicating with the circulation flow channel. Then, while the printing medium S is continuously conveyed, multiple ejection elements provided to face the corresponding multiple ejection ports of the printing head 10 are driven based on printing data, and the ink is ejected as a droplet from the ejection ports corresponding to the ejection elements. Thus, an image is printed on the printing medium S.

Next, the control system of the printing apparatus 1 is described with reference to FIG. 1B. As illustrated in FIG. 1B, a control unit 2 includes a CPU 21, a ROM 22, and a RAM 23. The CPU 21 serves as a control unit that controls overall the printing apparatus 1 while using the RAM 23 as a working area in accordance with a program stored in the ROM 22. For example, the CPU 21 performs predetermined image processing on image data, which is received from a host apparatus 30 connected externally, in accordance with the program and a parameter stored in the ROM 22. The CPU 21 then outputs printing data to an ejection driving circuit 201d and the ejection driving circuit 201d generates ejection data to cause multiple ejection elements (ejection units) 201 of the printing head 10 to perform ejection at a predetermined frequency. According to the ejection data, ejection energy for the multiple ejection elements 201 to eject the ink is generated, and the ink is ejected from the ejection ports with the ejection energy. As the ejection element, an electrothermal conversion element (heater), a piezo element, and the like can be used. In a case where the electrothermal conversion element is used, film boiling occurs in the ink by heating the electrothermal conversion element, and the bubble generation energy in the film boiling is used as the ejection energy to eject the ink from the ejection port. During the ink ejection operation by the printing head 10, a conveyance motor that moves the conveyance belt 20A illustrated in FIG. 1A is driven through a conveyance driving circuit 11d, and the printing medium S is conveyed in the X direction at a speed corresponding to the above-described predetermined frequency. With this, an image corresponding to the image data received from the host apparatus 30 is printed on the printing medium S.

In the printing head 10, a liquid transportation mechanism 208 that generates a pressure to flow the ink in the circulation flow channel is provided. The liquid transportation mechanism 208 is driven by a voltage applied from a liquid transportation driving circuit 208d, and an operation of the liquid transportation driving circuit 208d is controlled by the CPU 21. Details of the liquid transportation mechanism 208 and driving control thereof are described later.

FIG. 2 is a perspective view of the printing head used in the present embodiment. The printing head 10 includes multiple element substrates 114 in which the multiple ejection elements are arrayed in the Y direction. The multiple element substrates 114 are arrayed in the Y direction. Here is illustrated the full line type ink jet printing head 10 in which the element substrates 114 are arrayed in the Y direction for a distance corresponding to the width of A4 size.

Each of the element substrates 114 is connected to the same electric wiring substrate 102 through a flexible wiring substrate 101. On the electric wiring substrate 102, a power supply terminal 103 that accepts power and a signal input terminal 104 that receives an ejection signal are arranged. The power supplied to the power supply terminal 103 and the signal received by the signal input terminal 104 are supplied from the ejection driving circuit 201d and the liquid transportation driving circuit 208d.

On the other hand, in the ink supply unit 105, there is formed a flow channel to supply the individual element substrate 114 with the ink supplied from a not-illustrated ink tank and collect the ink that is not consumed for printing.

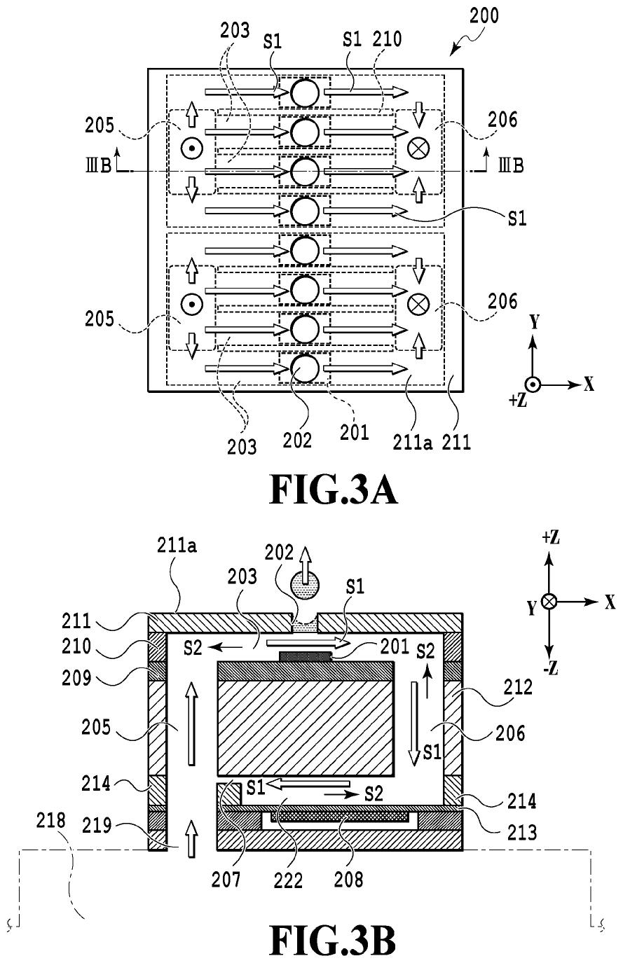

FIGS. 3A and 3B are diagrams illustrating a flow channel configuration of one flow channel block 200 in the element substrate 114. Multiple flow channel blocks 200 are formed in each element substrate 114, and FIG. 3A is a plan view in which one of the multiple flow channel blocks is viewed from an ejection port surface 211a side. FIG. 3B is a cross-sectional view taken along the IIIB-IIIB line in FIG. 3A.

As illustrated in FIG. 3A, each flow channel block 200 includes eight ejection ports 202 arrayed in the Y direction, eight pressure chambers 203 communicating with the ejection ports 202, respectively, two supply flow channels (first flow channels) 205, and two collection flow channels (second flow channels) 206. Each of the two supply flow channels 205 connected to a common liquid chamber (liquid supply unit) 218 supplies the four pressure chambers 203 with the ink commonly, and each of the two collection flow channels 206 collects the ink from the four pressure chambers 203 commonly. One liquid transportation mechanism 208, which is described later, is provided for each flow channel block.

The combination of the ejection ports 202, the pressure chambers 203, the supply flow channels 205, and the collection flow channels 206 provided in each flow channel block is not limited to the example illustrated in FIG. 3A. For example, each flow channel block may include the four ejection ports 202, the four pressure chambers 203 communicating with the corresponding ejection ports 202, the one supply flow channel 205, and the one collection flow channel 206. In this case, the one supply flow channel 205 connected to the common liquid chamber 218 supplies the four pressure chambers 203 with the ink commonly, and the one collection flow channel 206 collects the ink from the four pressure chambers 203 commonly. It is ideal for the liquid transportation mechanism (liquid transportation unit) 208 to perform control corresponding to each ejection port; for this reason, if it is possible to produce a small liquid transportation mechanism 208, each flow channel block is desired to have a smaller configuration. In the present embodiment, a structure portion in which the ejection ports 202, the ejection elements 201, and the pressure chambers 203 are combined with each other is referred to as an ejection unit.

As illustrated in FIG. 3B, the element substrate 114 of the present embodiment includes a second substrate 213 (vibration plate), a middle layer 214, a first substrate 212, a functional layer 209, a flow channel formation member 210, and an ejection port formation member 211 that are laminated in this order in a +Z direction. On a surface of the functional layer 209, the ejection elements 201 as the electrothermal conversion element are arranged, and in the ejection port formation member 211, the ejection ports 202 are formed in positions corresponding to the ejection elements 201. Between the multiple ejection elements 201 arrayed in the Y direction, the flow channel formation member 210 laid between the functional layer 209 and the ejection port formation member 211 is arranged as partitions and forms the pressure chambers 203 corresponding to the individual ejection elements 201 and ejection ports 202.

The ink stored in each pressure chamber 203 forms a meniscus in the ejection port 202 in a stable state. Once a voltage pulse is applied to the ejection element 201 in accordance with the ejection signal, film boiling occurs in the ink that is put in contact with the ejection element 201, and the ink is ejected as a droplet from the ejection port 202 in the +Z direction with the growth energy of the generated bubble.

The ink in the pressure chamber 203 consumed by the ejection operation is newly supplied by the capillary force of the pressure chamber 203 and the ejection port 202, and a meniscus is formed again in the ejection port 202.

As illustrated in FIG. 3B, in the element substrate 114 of the present embodiment, the circulation flow channel is formed with each of the second substrate 213, the middle layer 214, the first substrate 212, the functional layer 209, the flow channel formation member 210, and the ejection port formation member 211 serving as a wall. The circulation flow channel can be sectioned into the supply flow channel 205, the pressure chamber 203, the collection flow channel 206, a liquid transportation chamber 222, and a connection flow channel 207.

The pressure chamber 203 is provided for each ejection element 201. The supply flow channel 205 and the collection flow channel 206 are provided for every four ejection elements 201 in the flow channel block 200. The supply flow channel 205 supplies the four pressure chambers 203 with the ink commonly, and the collection flow channel 206 collects the ink from the four pressure chambers 203 commonly.

One liquid transportation chamber 222 and one connection flow channel 207 are provided for every four ejection elements. Accordingly, two liquid transportation chambers 222 and two connection flow channels 207 are provided in each flow channel block 200. Each liquid transportation chamber 222 is arranged in a position overlapped with the four ejection elements 201 in an XY plane. In each liquid transportation chamber 222, the liquid transportation mechanism 208 capable of changing the inner volume of each liquid transportation chamber 222 is arranged, and the liquid transportation mechanism 208 circulates the ink for the four pressure chambers 203 commonly. The connection flow channel 207 is arranged in the substantially center in the Y direction of a range in which the four pressure chambers 203 are formed and connects the liquid transportation chamber 222 with the supply flow channel 205. The position of the supply flow channel connected with the connection flow channel 207 is a position upstream of a diverging point into the two supply flow channels 205.

In the above configuration, with the liquid transportation mechanism 208 driven by applying a later-described voltage thereto, the circulation can be made in the circulation flow channel formed in each flow channel block 200 through a supply port 219 from the common liquid chamber 218. That is, the ink can be flowed in the order of the supply flow channel 205, the pressure chamber 203, the collection flow channel 206, the liquid transportation chamber 222, and the connection flow channel 207 of each flow channel block 200. This circulation of the ink (liquid) is referred to as a first circulation, and the flow of the circulated ink is referred to as a first circulation flow. On the other hand, the circulation in which the ink flows in the order of the supply flow channel 205, the connection flow channel 207, the liquid transportation chamber 222, the collection flow channel 206, the pressure chamber 203, and the supply flow channel 205 is referred to as a second circulation, and the flow of the circulated ink is referred to as a second circulation flow.

The flowing direction of the ink can be switched by changing a voltage waveform applied to the liquid transportation mechanism 208. The voltage waveform is described later. The circulation of the ink is stably performed regardless of whether there is the ejection operation or the frequency of the ejection operation, and it is possible to supply fresh ink constantly to the vicinity of the ejection port 202. Although it is not illustrated, it is favorable to provide a filter for preventing entering of foreign matters or air bubbles in the middle of the supply flow channel 205 upstream of the pressure chamber 203. As a filter, a columnar structure or the like can be employed.

The element substrate 114 can be manufactured as follows, for example. First, a structure is formed in advance in each of the first substrate 212 and the second substrate 213. Thereafter, the first substrate 212 and the second substrate 213 are pasted together with the middle layer 214 arranged therebetween, the middle layer 214 including a groove that is formed in a position in which the connection flow channel 207 is formed later. With this, the element substrate 114 can be manufactured.

Here is described a specific dimension example of each ejection unit formed in the element substrate 114. In the present embodiment, the individual ejection elements 201, ejection ports 202, and pressure chambers 203 are arrayed in the Y direction at a density of 600 npi (nozzles per inch). The size of the ejection element 201 is 20 μm×20 μm, the diameter of the ejection port 202 is 18 μm, and the thickness of the ejection port 202, that is, the thickness of the ejection port formation member 211 is 5 μm. The size of the pressure chamber 203 is the length in the X direction (length) of 100 μm×the length in the Y direction (width) of 37 μm×the length in the Z direction (height) of 5 μm. The viscosity of the ink to be used is 2 cP, and the ink ejection amount from the individual ejection port is 2 pL.

In the present embodiment, the driving frequency of the individual ejection element 201 is 10 KHz. Such a driving frequency is set based on the time required to apply a voltage to the individual ejection element, the ink is actually ejected, new ink is refilled additionally, and the next ejection operation is available in the individual ejection element 201.

On the other hand, in the element substrate 114 of the present embodiment, the size of the liquid transportation chamber 222 is designed appropriately in accordance with an area occupied by the flow channel block. For example, in a case of the flow channel block including the eight pressure chambers 203 (600 npi), the size of the liquid transportation chamber 222 is 250 μm in the X direction×290 μm in the Y direction×250 μm in the Z direction. In a case of the flow channel block including the four pressure chambers 203 (600 npi), the size of the liquid transportation chamber 222 is 250 m in the X direction×120 μm in the Y direction×250 μm in the Z direction. The size of the connection flow channel 207 is based on 25 μm in the X direction×25 μm in the Y direction×25 μm in the Z direction. Additionally, the flow channel width (cross-section area) is optimized such that the liquid transportation efficiency is maximized in view of a flow channel load ratio (the connection flow channel 207, the supply flow channel 205, the pressure chamber 203, and the collection flow channel 206) with respect to the liquid transportation chamber 222.

In the present embodiment, with the dimension relationship as described above, the flow channel resistance and the inertance of the connection flow channel 207 are lower than the flow channel resistance and the inertance of a flow channel as a combination of the supply flow channel 205, the collection flow channel 206, and the pressure chamber 203. Here, “the flow channel resistance and the inertance of a flow channel as a combination of the supply flow channel 205, the collection flow channel 206, and the pressure chamber 203” indicates a total of a sum of the parallel flow channel resistances of the respective supply flow channel 205, multiple pressure chamber 203, and collection flow channel 206 and a sum of the series flow channel resistances thereof. The dimension values of the portions described above are merely an example and may be changed as needed in accordance with required specifications.

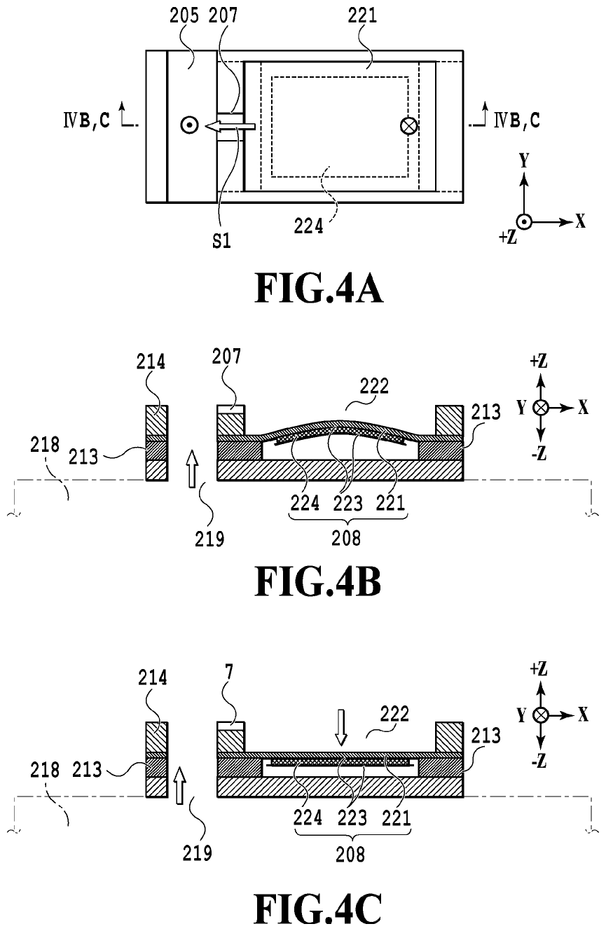

FIGS. 4A to 4C are schematic views describing a structure and operations of the liquid transportation device including the liquid transportation mechanism 208. The liquid transportation device (pump) includes the liquid transportation mechanism (liquid transportation unit) 208 and the liquid transportation chamber 222. The liquid transportation mechanism 208 configured with a piezoelectric actuator which includes a thin film piezoelectric element (hereinafter, simply referred to as a piezoelectric element) 224, two electrodes 223 sandwiching the thin film piezoelectric element 224 from the front and back surfaces, and a diaphragm 221. The liquid transportation mechanism 208 is arranged on the second substrate 213 such that the diaphragm 221 is exposed to the liquid transportation chamber 222.

The diaphragm 221 mainly includes a laminate including an inorganic material with a thickness of about few m and a piezoelectric element with a thickness of about 1 to 3 μm. With a voltage applied to the piezoelectric element 224 through the two electrodes 223, the diaphragm 221 is bent with respect to the piezoelectric element 224, and the inner volume of the liquid transportation chamber 222 is changed. That is, with a change in the voltage applied to the two electrodes, the diaphragm 221 can be displaced in the ±Z directions, and the inner volume of the liquid transportation chamber 222 can be changed.

It is possible to form the liquid transportation device (pump) including such a liquid transportation mechanism 208 by using general-purpose Micro Electro Mechanical Systems (MEMS) technology. For example, the liquid transportation device including the liquid transportation mechanism 208 can be formed by vacuum plasma etching, anisotropic etching using an alkaline solution, or a combination thereof performed on an Si substrate (silicon substrate). The liquid transportation device may be formed by forming a flow channel including the liquid transportation chamber 222 and the liquid transportation mechanism 208 separately on multiple Si substrates and thereafter bonding or adhering the flow channel and the liquid transportation mechanism 208 to paste them together.

A unimorph piezoelectric actuator is used for the liquid transportation mechanism 208. The unimorph piezoelectric actuator is formed by forming the piezoelectric element 224 on one surface side of the second substrate (also called a vibration plate) 213. A material of the vibration plate 213 is not particularly limited as long as the conditions such as required mechanical characteristics and endurance reliability are satisfied. For example, silicon nitride film, silicon, metal, heat-resistant glass, and the like can be used properly.

The piezoelectric element 224 can be film-formed by using a method such as vacuum sputtering film formation, sol-gel film formation, and CVD film formation and is fired after the film formation in many cases. The firing method is not particularly limited; however, for example, a lamp annealing heating method in which firing at about 650° C. at the maximum is performed under oxygen atmosphere can be employed. In view of consistency with a process flow, the piezoelectric element 224 may be directly film-formed on the vibration plate 213 and fired integrally or may be film-formed on a substrate different from the vibration plate 213 to be fired and then peeled and transferred onto the vibration plate 213. Alternatively, the piezoelectric element 224 may be film-formed on a substrate different from the vibration plate 213 and then fired integrally after being peeled and transferred onto the vibration plate 213.

For the electrodes 223, it is preferable to select a Pt or Ir system if the firing process is included; however, if the firing process can be separated, an AL system is selectable. In the present embodiment, a piezoelectric material of PZT system is used for the piezoelectric element 224, and for the electrodes 223, a material that allows the piezoelectric element 224 to be displaced with a state of high linearity, that is, being highly responsive to the applied voltage is used. As the outermost layer exposed to the atmosphere, a protection film of SiN system is used, and the entire liquid transportation mechanism 208 may be sealed with the protection film.

Then, a relay board for transmitting a signal wiring to the liquid transportation device and the liquid transportation device are adhered to a not-illustrated holding frame body, and the liquid transportation device and the relay board are electrically implemented by wire bonding. Additionally, a manifold to be an inlet port and an outlet port of the ink is fixed with an adhesive agent so as to be connected to the supply flow channel (first flow channel) 205 and the collection flow channel (second flow channel) 206.

FIGS. 4B and 4C are diagrams illustrating a state of displacement of the piezoelectric element 224 in a case where the voltage is applied to the piezoelectric element 224 in the liquid transportation mechanism 208 formed as described above. FIG. 4B illustrates a standby state where a constant bias voltage (hereinafter, also referred to as an initial voltage) is applied to the piezoelectric element 224. In the standby state, the diaphragm 221 is in a state where the inner volume of the liquid transportation chamber 222 is contracted. On the other hand, FIG. 4C illustrates a state where the inner volume of the liquid transportation chamber 222 is expanded from the standby state in a case where a transitional waveform of about 30 V is applied to the piezoelectric element 224 as the maximum voltage (hereinafter, also referred to as a reached voltage). The diaphragm 221 is displaced between the standby state illustrated in FIG. 4B and the expansion state illustrated in FIG. 4C in accordance with the amount of the voltage applied to the piezoelectric element 224.

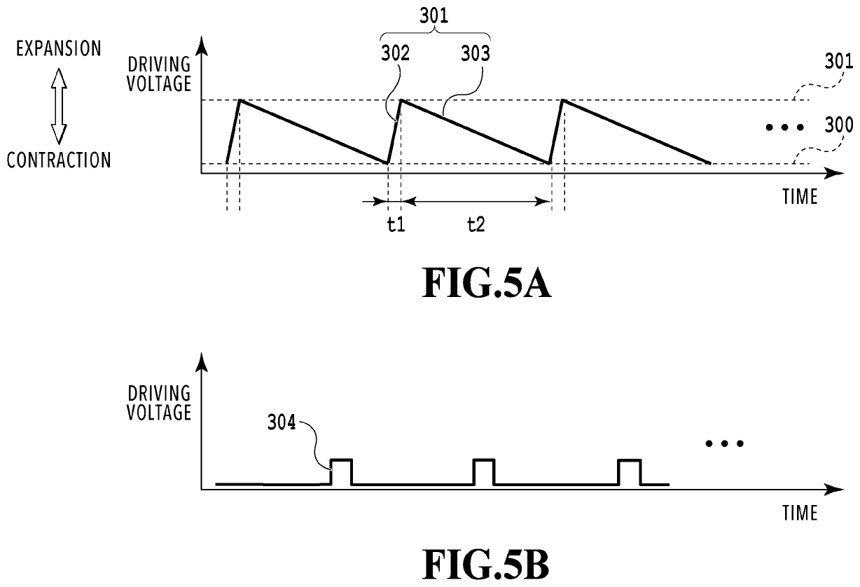

FIG. 5A is a diagram illustrating a waveform of a driving voltage applied to the piezoelectric element 224. The waveform of the voltage (driving voltage) applied to the piezoelectric element 224 is a triangle wave 301 as illustrated in FIG. 5A. The triangle wave 301 includes a step-up waveform 302 that is changed from the initial voltage to the reached voltage and a step-down waveform 303 that is changed from the reached voltage to the initial voltage. The triangle wave 301 used in the present embodiment is a waveform in which a voltage change period (step-up period) t1 in the step-up waveform 302 and a voltage change period (step-down period) t2 in the step-down waveform 303 are different. That is, the triangle wave 301 used in the present embodiment is a triangle wave in which the step-up waveform 302 and the step-down waveform 303 are asymmetrically changed with respect to time.

In the present specification, an absolute value of a voltage change amount per unit time (voltage change rate) is referred to as a rate. Additionally, the rate in the step-up waveform 302 is referred to as a step-up rate, and the rate in the step-down waveform 303 is referred to as a step-down rate; the rates are defined as follows:

step-up rate=|(reached voltage−initial voltage)|/step-up period;

step-down rate=|(reached voltage−initial voltage)|/step-down period.

It is preferable to use an asymmetric triangle wave in order to maximize a difference between a rapid change and a moderate change in a deformation speed of the diaphragm 221; however, a trapezoidal waveform including a component of an asymmetric triangle wave that generates a rapid change and a moderate change may also be used. In the present specification, descriptions are given by using an asymmetric triangle wave.

In the triangle wave 301 exemplified in FIG. 5A, the step-up period t1 is set to be a period shorter than the step-down period t2; thus, the step-up rate in the step-up waveform 302 is greater than the step-down rate in the step-down waveform 303. That is, the triangle wave 301 exemplified in FIG. 5A is a waveform in which the voltage is changed rapidly in the step-up period and the voltage is changed moderately in the step-down period.

In a case where such a triangle wave 301 is applied to the piezoelectric element 224, in the step-up period t1, the piezoelectric element 224 is displaced in a direction in which the liquid transportation chamber 222 is expanded rapidly by the step-up waveform 302 with the great rate. On the other hand, the step-down waveform 303 is a waveform in which the voltage drops moderately in the step-down period t2. With the step-down waveform 303 applied to the piezoelectric element 224, the piezoelectric element 224 is displaced in a direction in which the liquid transportation chamber 222 is contracted moderately. As a result, in the liquid transportation chamber 222, a flow in a direction illustrated in FIG. 4A (hereinafter, this direction is referred to as a first direction S1) is generated, and a similar flow is accordingly generated in the pressure chamber 203 as well.

As the driving voltage of the piezoelectric element 224, it is also possible to use a triangle wave in which the step-down period t2 is set to be a period shorter than the step-up period t1. In the triangle wave, the voltage drops rapidly in the step-down waveform 303, and the voltage rises moderately in the step-up waveform 302. In this case, with the step-up waveform 302 applied, the piezoelectric element 224 is displaced in a direction in which the liquid transportation chamber 222 is expanded moderately. With the step-down waveform 303 applied, the piezoelectric element 224 is displaced in a direction in which the liquid transportation chamber 222 is contracted rapidly. As a result, in the flow channel block 200, a flow in an opposite direction of the first direction S1 (second direction S2) is generated.

As described above, the driving voltage of the piezoelectric element used in the present embodiment includes the step-up period and the step-down period, and those two voltage change periods are periods different from each other. That is, one is a period shorter than the other, and the piezoelectric element 224 is changed more rapidly by the voltage waveform that is changed in the short period (first period), and a more rapid flow of the ink is generated.

Here is simply described a mechanism of generating a constant flow by making a rapid inner volume change and a moderate inner volume change in the liquid transportation chamber 222. In a case where the liquid transportation chamber 222 is expanded rapidly, a vortex is generated under a high flow velocity on a side of the connection flow channel 207 with a small area of flow channel cross-section, and the flow channel resistance is increased greatly. As a result, flow of the ink from the connection flow channel 207 into the liquid transportation chamber 222 is obstructed. In contrast, on a side of the connection flow channel 207 with a wide area of flow channel cross-section, a variation in the flow channel resistance due to a flow velocity is less, and the ink flows smoothly from the collection flow channel 206 into the liquid transportation chamber 222. Thereafter, once the liquid transportation chamber 222 is contracted moderately, the ink in the liquid transportation chamber 222 flows to the connection flow channel 207 side at a low speed; thus, no vortex is generated and an increase in the flow channel resistance is suppressed, and therefore the ink in the liquid transportation chamber 222 flows moderately to the supply flow channel side through the connection flow channel 207. Thus, with the rapid expansion and the moderate contraction of the liquid transportation chamber 222, the flow in the first direction S1 from the collection flow channel 206 to the supply flow channel 205 through the liquid transportation chamber 222 and the connection flow channel 207 is generated, and the first circulation is performed.

In a case where the liquid transportation chamber 222 is contracted rapidly, a vortex is generated under a high flow velocity on the side of the connection flow channel 207 with a small area of flow channel cross-section, and the flow channel resistance is increased greatly. As a result, flowing out of the ink from the liquid transportation chamber 222 to the connection flow channel 207 is obstructed. In contrast, on the side of the connection flow channel 207 with a wide area of flow channel cross-section, the ink smoothly flows out from the liquid transportation chamber 222 to the collection flow channel. Thereafter, once the liquid transportation chamber 222 is expanded moderately, the ink flows from the connection flow channel 207 into the liquid transportation chamber 222 at a low speed. Accordingly, with the rapid contraction and the moderate expansion of the liquid transportation chamber 222, the flow of the ink in the second direction S2 from the connection flow channel 207 to the collection flow channel 206 through the liquid transportation chamber 222 is generated, and the second circulation is performed.

In the printing head 10 used in the ink jet printing apparatus, the ink (liquid) may be deteriorated because of evaporation of volatile components in the ejection port in which the ejection operation is not performed for a while. If the degree of the evaporation is varied between multiple ejection ports depending on the ejection frequency, the ejection amount and the ejection direction are also varied, and unevenness in the density and a streak may be found in an image. For this reason, in the ink jet printing head 10, it is necessary to flow the ink in the flow channel block 200 in order to constantly supply fresh ink to the vicinity of the ejection port. However, in a case where a great pressure variation during the flow of the ink is propagated to the ejection port, the ejection of the liquid droplet from the ejection port may be affected. Therefore, it is required to achieve both the appropriate ejection of the liquid droplet and liquid transportation operation.

FIG. 5B is a diagram illustrating an ejection signal 304 that prompts generation of the ejection energy to eject the liquid droplet in the ejection element 201. In the present embodiment, in order to achieve both the appropriate ejection of the liquid droplet and liquid transportation operation, timings of the driving voltage inputted to the piezoelectric element 224 and the ejection signal are controlled. Specifically, the application timing of the driving voltage is controlled such that the period in which the rapid voltage change occurs within the triangle wave applied to the liquid transportation mechanism 208 (voltage application period) and the ejection signal 304 do not coincide with each other. For example, since the step-up rate is greater than the step-down rate in the driving voltage (triangle wave) illustrated in FIG. 5A, the application timing of the driving voltage is controlled such that the step-up period t1 with the great rate does not coincide with an ejection period t3 of the ink. With this, as described later, both the appropriate ejection of the liquid droplet and liquid transportation operation can be achieved. Details of the application timing of the driving voltage are described later.

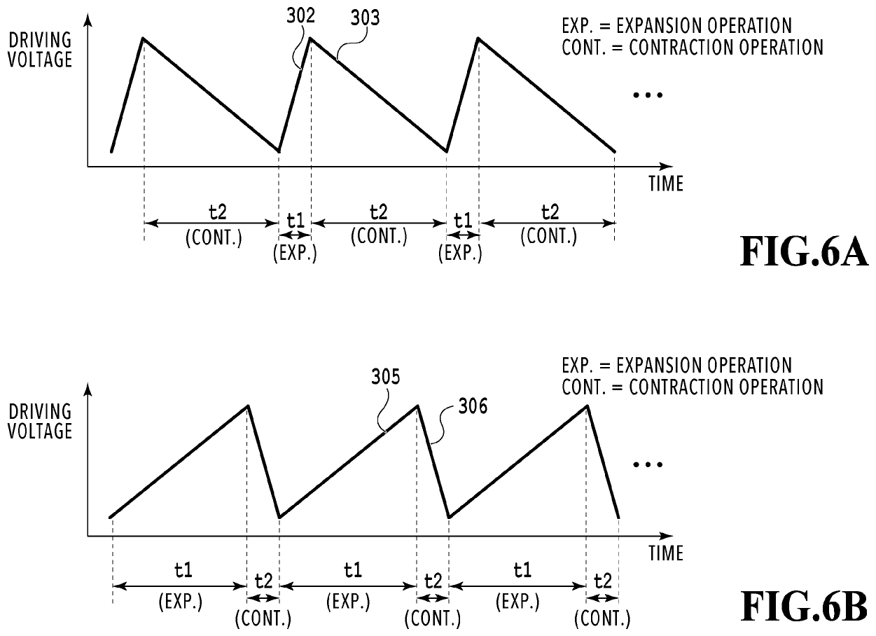

Next, liquid transportation control in the printing head 10 of the present embodiment is described in more details. FIGS. 6A and 6B illustrate waveforms of two types of driving voltages applied to the piezoelectric element 224 of the liquid transportation mechanism 208. Although it is not illustrated in FIGS. 6A and 6B, usually, a transient waveform as illustrated in FIG. 5A is applied in actuality in a state where a bias voltage (not illustrated) is applied. As a waveform of the driving voltage, it is necessary to apply a waveform in which the step-up period t1 and the step-down period t2 are different from each other.

FIG. 6A illustrates a case of repeatedly applying a driving voltage (first driving voltage) including the step-up waveform 302 with a high rate prompting the rapid expansion of the inner volume of the liquid transportation chamber 222 and the step-down waveform 303 with a low rate prompting the moderate contraction of the inner volume of the liquid transportation chamber 222. With this driving voltage applied to the piezoelectric element 224, a flow of the ink toward a first flow direction (S1 direction) is formed in the pressure chamber 203.

On the other hand, FIG. 6B illustrates a driving voltage (second driving voltage) including a step-up waveform 305 prompting the moderate expansion of the inner volume of the liquid transportation chamber 222 and a step-down waveform 306 prompting the rapid contraction. In a case where this driving voltage is applied to the piezoelectric element 224, a flow of the ink toward a second direction (S2 direction), which is an opposite direction of the first direction, is formed in the pressure chamber 203.

Thus, in the present embodiment, liquid transportation of a constant amount of the ink in the S1 direction or the S2 direction can be performed with cycles of the rapid inner volume change and the moderate inner volume change in the liquid transportation chamber 222 by using the fluid characteristics that the flow channel resistance is non-linearly changed in accordance with a pressure. This liquid transportation operation may be continuously repeated by continuously applying the driving voltage as illustrated in FIGS. 6A and 6B or may be intermittently performed by intermittent applying the driving voltage (not illustrated).

Thus, in the present embodiment, a function as the liquid transportation device (also called a pump) is achieved by the flow channel that includes the liquid transportation chamber 222 and the liquid transportation mechanism 208 as a driving source, in which the flow channel resistance is non-linearly changed by a flow velocity of the ink flowed by the liquid transportation mechanism 208. A merit of the configuration of this pump may include improvement in the reliability obtained by not using a mechanical part to implement a valve function. However, a valve using the non-linearity of the flow channel resistance like the present embodiment has a lower performance as a check valve than a valve using a mechanical part, and thus the liquid transportation efficiency is low. For this reason, it is favorable to perform the circulation of the ink in the vicinity of the ejection port 202 in the ejection unit of the liquid droplet, and to this end, the liquid transportation chamber 222 needs to be arranged in a flow channel in the vicinity of the nozzle. In this case, once the rapid inner volume change occurs in the liquid transportation chamber 222, a great pressure applied to the ink due to the rapid inner volume change is likely to be propagated to the ejection port 202, and this may affect the ejection of the liquid droplet. If a rapid pressure variation occurs in the liquid transportation chamber 222 during the ejection operation of the liquid droplet, the ejection characteristics such as the ejection amount and the ejection direction of the liquid droplet are likely to be varied due to the effect of the pressure variation.

The liquid transportation chamber 222 communicates with the common liquid chamber 218, and in a case where there are the multiple liquid transportation chambers 222, the liquid transportation chambers 222 communicate with each other through the common liquid chamber 218. Once the rapid inner volume variation occurs in the liquid transportation chamber 222, a great pressure is propagated also to a common liquid chamber 218 side. Once the multiple liquid transportation mechanisms 208 are operated concurrently, pulsation close to the ejection cycle occurs in the common liquid chamber 218, and a variation in the meniscus positions in the ejection ports 202 is caused. As a result, the ejection characteristics is likely to be varied. The preconditions for stable liquid transportation is that the pressure in the common liquid chamber 218 with respect to the liquid transportation chamber 222 is a constant open pressure. Accordingly, an increase and decrease in the pressure in the common liquid chamber 218 from the open pressure is unfavorable because the liquid transportation operation itself is affected.

Here, the voltage waveform that causes the rapid inner volume change in the liquid transportation chamber 222 is the step-up waveform 302 prompting the expansion operation of the liquid transportation chamber 222 in FIG. 6A and is the step-down waveform 306 prompting the contraction operation in FIG. 6B. Once the rapid expansion operation is performed in the liquid transportation chamber 222, a negative pressure is generated instantly in the vicinity of the liquid transportation chamber 222 in the common liquid chamber 218. Once the rapid contraction operation is performed in the liquid transportation chamber 222, a positive pressure is generated instantly in the vicinity of the liquid transportation chamber 222 in the common liquid chamber 218.

In a case where the piezoelectric element 224 is used as the driving source of the liquid transportation mechanism 208, a time corresponding to the rapid inner volume change in the liquid transportation chamber 222 (t1 in FIG. 6A, and t2 in FIG. 6B) is about 2.5 to 10 μsec depending on the design dimension of the liquid transportation device (pump).

The voltage waveform that causes the moderate inner volume change in the liquid transportation chamber 222 is the step-down waveform 303 prompting the contraction operation of the liquid transportation chamber 222 in FIG. 6A and is the step-up waveform 305 prompting the expansion operation in FIG. 6B. In a case where the piezoelectric element (piezoelectric element 224) is used as the driving source of the liquid transportation mechanism 208, a time corresponding to the moderate operation (t2 in FIG. 6A, and t1 in FIG. 6B) is about 30 to 100 μsec depending on the design dimension of the pump.

In the above configuration, in order to achieve both the appropriate ejection operation of the liquid droplet and liquid transportation operation by the liquid transportation mechanism 208, satisfying the following conditions for the ejection operation of the liquid droplet and the liquid transportation operation is effective.

(1) The ejection operation timing of the liquid droplet and the rapid inner volume variation timing in the liquid transportation chamber 222 do not coincide with each other.

(2) The number of the liquid transportation mechanisms 208 driven concurrently is small.

(3) The liquid transportation operations in opposite phases are performed in the liquid transportation mechanisms 208 arranged adjacent to each other or in the vicinity to compensate the pressure generated in the common liquid chamber 218.

In order to satisfy the above-described conditions, in the present embodiment, driving control of the ejection elements 201 that generate the ejection energy of the liquid droplet and the liquid transportation mechanisms 208 is performed according to the sequence below.

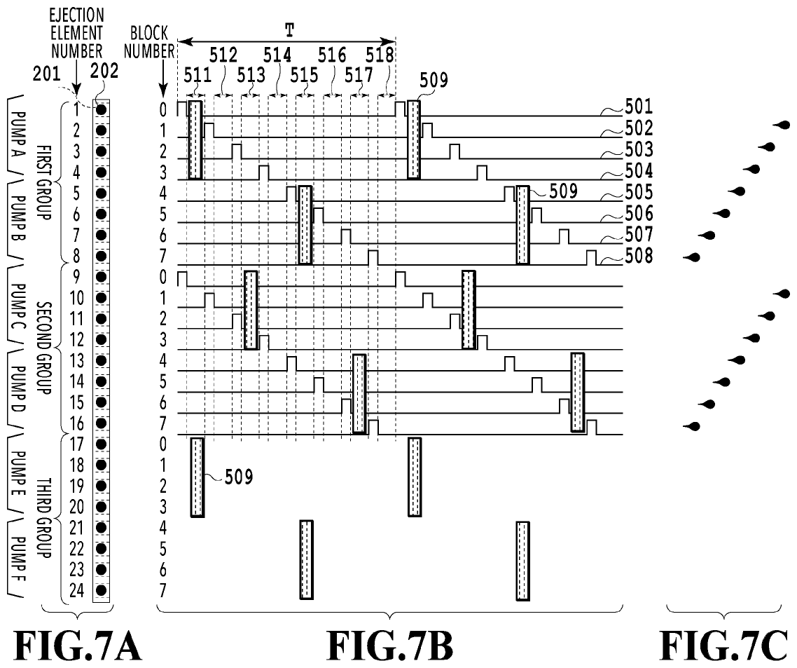

FIGS. 7A to 7C are timing charts illustrating a driving sequence of the ejection elements 201 and the pumps.

First, driving timings of the multiple ejection elements 201 provided in the printing head 10 are described. As described above, in the printing head 10, an ejection port row including the multiple ejection ports 202 is formed, and the multiple ejection elements 201 are arranged corresponding to the multiple ejection ports 202. Hereinafter, a row including the multiple ejection elements 201 is referred to as an ejection element row. The ejection element row is divided into multiple groups for every predetermined number of the ejection elements in accordance with physical array positions. The inside of each group is divided into driving blocks driven for corresponding ejection elements in different timings, and block numbers are provided to the driving blocks, respectively.

Here is more specifically described the group and the driving block in the printing head 10 with reference to FIG. 7A. The ejection element row illustrated in FIG. 7A is divided into N groups from a first group to a not-illustrated Nth group. Each group includes the eight ejection elements 201. Thus, the ejection element row includes 8×N (not-illustrated) ejection elements 201. The ejection elements of the ejection port row is provided with ejection element numbers of 1 to (8×N) according to the arrayed order. In FIG. 7A, for the sake of simplifying the descriptions, as the ejection element row, first to third groups are illustrated and first to twenty-fourth ejection elements are illustrated. The first group includes first ejection element to eighth ejection element, the second group includes ninth ejection element to sixteenth ejection element, and the third group includes seventeenth ejection element to twenty-fourth ejection element.

The ejection elements of each group are divided into eight blocks driven in different timings, and each ejection element belongs to any one of a zeroth block to a seventh block. That is, first, ninth, seventeenth, and not-illustrated twenty-fifth, thirty-third, forty-first . . . belong to the zeroth block, and second, tenth, eighteenth, and twenty-sixth, thirty fourth, four second . . . belong to the first block. The same applies to the second to seventh blocks, and those eight blocks are driven with time-division.

In the printing head 10 formed as above, all the ejection elements are driven in accordance with pulses (ejection timing signals) 501 to 508 illustrated in FIG. 7B in the ascending order from the zeroth block to the seventh block. That is, the blocks are sequentially driven in eight different timings in a cycle T. With this, the liquid droplet (ink droplet) is ejected from the ejection port 202 corresponding to each ejection element 201 in a temporal relation illustrated in FIG. 7C. Thus, the multiple ejection elements 201 are driven with time-division.

Since it is possible to suppress the power consumption in the printing operation by dividing the number of the ejection elements driven concurrently, the time-division method is an effective method for downsizing an electric power source for driving the printing head and a member for the electric power source such as a connector and a cable. In a case of the printing head using a heater as the ejection element, reduction of a voltage variation and fine adjustment of a voltage value are required in order to perform stable ejection taking into consideration the characteristics of the heater, the ink, and the like. Thus, with the time-division driving, it is possible to reduce the capacity of the electric power source, and it is possible to satisfy the requirements relating to the electric power source.

As described above, in a case where the time-division driving is performed in eight different timings, for example, if the cycle T is 10 KHz (100 μsec), a timing difference between adjacent ejection signals is 12.5 μsec. Since the ejection signal is about 1 to 2 μsec, the following remaining period that is about 10 μsec is a blanking period. In the blanking period, no ejection signal is applied to each ejection element. As with the number of time-division, there are eight periods as the blanking period in which no ejection signal is applied in the cycle T. That is, in the cycle T illustrated in FIG. 7B, periods of 511, 512, 513, 514, 515, 516, 517, and 518 are the blanking period (pause period).

Next, a driving timing of the pump that is the liquid transportation device performing the liquid transportation operation in the circulation flow channel is described. In the example illustrated in FIG. 7A, each group of the printing element row includes the eight ejection elements 201. The four ejection elements 201 included in each group correspond to a pair of the supply flow channel 205 and the collection flow channel 206 as illustrated in FIG. 3A. Thus, one pump that is able to be driven independently is provided for every adjacent four ejection elements 201, and two pumps are provided for each group. Accordingly, pumps (pump A to pump F) that are able to be driven independently are provided for the first to third groups illustrated in FIG. 7A. The pump A corresponds to the first to fourth ejection elements, the pump B corresponds to the fifth to eighth ejection elements, the pump C corresponds to the ninth to twelfth ejection elements, the pump D corresponds to the thirteenth to sixteenth ejection elements, the pump E corresponds to the seventeenth to twentieth driving elements, and the pump F corresponds to the twenty-first to twenty-fourth ejection elements.

In FIG. 7B, 509 indicates a driving timing to drive each pump to rapidly change the inner volume of the liquid transportation chamber 222. The period in the driving timing 509 corresponds to the step-up period t1 in FIG. 6A or the step-down period t2 in FIG. 6B. The CPU 21 in the control unit 2 controls driving of the liquid transportation mechanism 208 through the liquid transportation driving circuit 208d such that the driving timing 509 is within a range of the blanking period (511, 512, 513, 514, 515, 516, 517, or 518).

In the example illustrated in FIGS. 7A to 7C, the driving timing 509 of the pump A is set in the blanking period 511. The driving timing 509 of the pump B is set in the blanking period 515, the driving timing 509 of the pump C is set in the blanking period 513, and the driving timing 509 of the pump D is set in the blanking period 517, respectively. Additionally, the driving timing 509 of the pump E is set in the blanking period 511 as with the pump A. With this, an impact of the pulsation that occurs during the liquid transportation on the liquid ejection can be minimized. Moreover, a variation in the pressure that occurs in the common liquid chamber 218 can also be suppressed by distributing the driving timings of the pumps as illustrated in FIG. 7B.

A waveform conformable to the triangle wave illustrated in FIG. 5A is used as the waveform of the driving voltage applied to the piezoelectric element 224 provided in the pump. For example, there is used a driving voltage with the maximum voltage of 30 V, the driving cycle of 50 μsec, the driving frequency of 20 KHz, the step-up period of 2.5 sec, and the step-down period of 47.5 μsec while the direction in which the inner volume of the liquid transportation chamber 222 is expanded is a positive direction of the voltage.

The above-described driving voltage was inputted to the liquid transportation mechanism of the pump, and a flow of the ink in the pressure chamber 203 was evaluated. As the evaluation method, commonly known Particle Tracking Velocimetry (PTV) was employed. With measurement of a flow velocity, it was confirmed that the ink is circulated at a favorable speed in the supply flow channel 205, the pressure chamber 203, the collection flow channel 206, the liquid transportation chamber 222, and the connection flow channel 207, and fresh ink can be supplied stably to the vicinity of the ejection port 202. In a state where the ink is circulated, the ejection operation of the liquid droplet (ink droplet) was started, and the situation of the ejection of the ink droplet was observed by a high-speed camera. The ejection situation of the liquid droplet was observed while changing the relationship between the driving timing of the ejection element to eject the liquid droplet and the timing of the rapid operation of the actuator.

With the driving timing 509 of the pump in which the inner volume of the liquid transportation chamber 222 is changed rapidly set to the blanking period including no ejection signal of the ejection element 201 as illustrated in FIG. 7B, it was confirmed that the ejection speed and the volume of the liquid droplet are stable. On the other hand, with the driving timing 509 of the pump in which the inner volume of the liquid transportation chamber 222 is changed rapidly set close to the timing of the ejection signal to coincide therewith, it was observed that the ejection speed of the liquid droplet is changed dramatically, and it was confirmed that the ejection characteristics become unstable. Additionally, with the ejection timing and the driving timing 509 pump set away from each other from the above state, it was confirmed that the liquid droplet is ejected stably.

In the above-described embodiment, the flow channel block 200 of the mode illustrated in FIGS. 3A and 3B is used; however, the configuration of the flow channel block is not limited to the mode illustrated in FIGS. 3A and 3B. The numbers of the ejection elements 201 and the pressure chambers 203 that circulate the ink with one liquid transportation mechanism 208 are appropriately changeable depending on the required density and liquid transportation performance of the ejection elements. For example, a mode in which one pump is allocated for two ejection elements, a mode in which one pump is allocated for eight ejection elements, or another mode may be applicable. The numbers of the supply flow channels 205 and the collection flow channels 206 provided in each flow channel block may be three or more, or may be one.

In FIGS. 3A and 3B, the element substrate 114 of a mode in which the ejection elements are arrayed in the Y direction in one row is described as an example; however, in the element substrate 114, two or more rows of the ejection element rows as illustrated in FIGS. 3A and 3B may be arranged in the X direction.

In the above-described embodiment, a mode in which the electrothermal conversion element is used as the ejection element 201 and the ink is ejected by the growth energy of the bubble generated by making film boiling on the electrothermal conversion element is applied; however, it is not limited to such an ejection method. For example, various types of elements such as a piezoelectric actuator, a static actuator, a mechanical/impact driving type actuator, a voice coil actuator, and a magnetostriction driving type actuator can be employed as the ejection element.

In the above descriptions, a configuration to perform the liquid transportation operation in the long full line type printing head 10 in which the ejection elements and the ejection ports are arrayed in a range corresponding to the width of the printing medium is described as an example; however, it is not limited thereto. A configuration to perform the liquid transportation operation in the printing head 10 indicated in the above-described embodiment is also applicable to and effective for a relatively short serial type printing head in which the ejection ports and the ejection elements are arrayed along a conveyance direction of the printing medium. Note that, since the ink is likely to be evaporated and deteriorated in the long full line type printing head 10, it is possible to enjoy more apparent effect by applying the configuration to perform the above-described liquid transportation operation to the full line type printing head.

### Second Embodiment

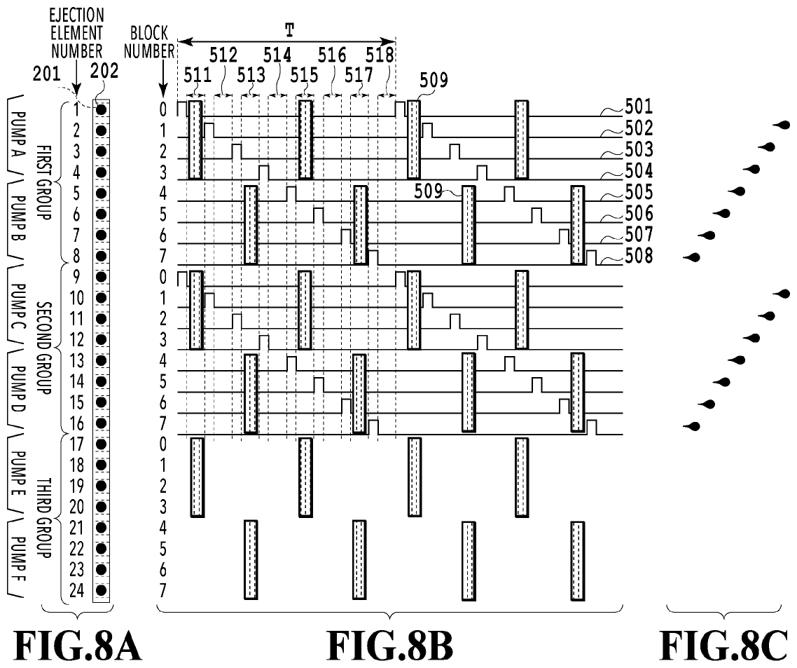

Next, a second embodiment of the present invention is described. The configuration of FIGS. 1A to 6B is similarly included in the present embodiment as well, and different points from the first embodiment are mainly described below. FIGS. 8A to 8C are timing charts illustrating a driving sequence of the ejection elements and the pumps in the second embodiment. In the present embodiment, the pumps are driven such that the liquid transportation efficiency by the pump is enhanced about twice the liquid transportation efficiency of the first embodiment.

The liquid transportation performance of the pump is substantially proportional to the number of operations per unit time. For this reason, in the present embodiment, the ejection cycle T of the ejection elements 201 is 100 μsec, the driving cycle of the liquid transportation mechanism 208 is 50 μsec, and two cycles of the driving voltages are inputted to each pump during the cycle T of the ejection elements. With this, in the second embodiment, the driving voltages are inputted continuously, and accordingly, the liquid transportation operations are also performed continuously. On the other hand, in the above-described first embodiment, one cycle of the driving voltage is inputted during the ejection cycle T, and thus the pump is driven intermittently.

As with the first embodiment, the flow of the ink in the pressure chamber 203 was evaluated by the PTV in the present embodiment as well. As a result, it was confirmed that the flow velocity of the ink in the pressure chamber 203 is improved about twofold. Additionally, with the ejection of the ink and the liquid transportation operation performed concurrently based on the present sequence, it was confirmed that the ejection operation of the liquid droplet is performed stably.

### Third Embodiment

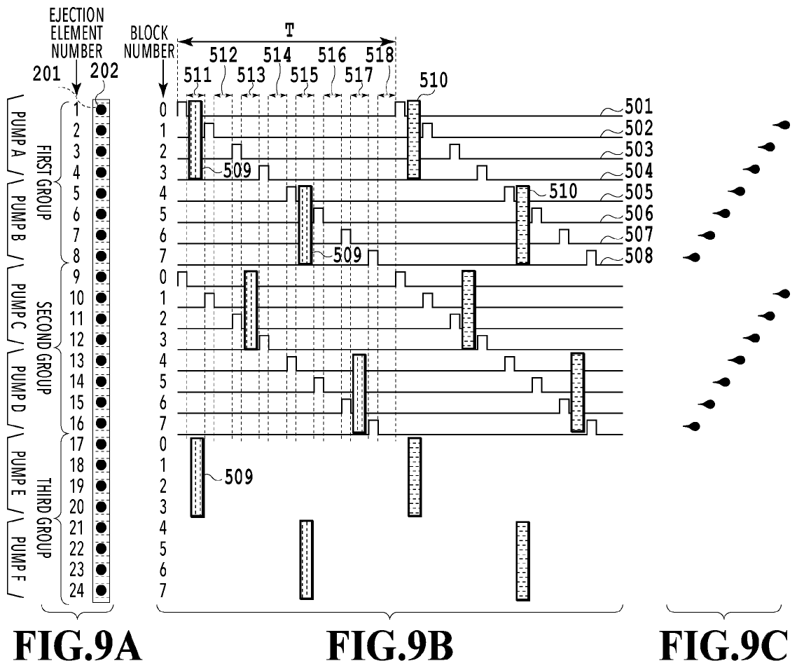

Next, a third embodiment of the present invention is described. FIGS. 9A to 9C are timing charts illustrating a driving sequence of the ejection elements and the pumps in the third embodiment. In the present embodiment, the liquid transportation is performed while switching the direction in which the liquid transportation is performed at a predetermined timing. The driving timing 509 (vertical broken line) illustrated in FIG. 9B indicates a timing of the liquid transportation of the ink in a forward direction (first direction), and a driving timing 510 (horizontal broken line) indicates a timing of the liquid transportation of the ink in an opposite direction of the forward direction (second direction). That is, FIGS. 9A to 9C illustrate a state where the flow direction of the ink is switched.

The liquid transportation direction of the ink can be switched by switching the voltage waveform of the driving voltage applied to the piezoelectric element 224 of the liquid transportation mechanism 208. For example, a flow in the forward direction is generated in the pressure chamber 203 by applying the driving voltage illustrated in FIG. 6A to the piezoelectric element 224 by a predetermined number of times. Thereafter, the driving voltage is switched to the driving voltage of the voltage waveform as illustrated in FIG. 6B at a predetermined timing. With this, a flow in the opposite direction can be generated. This switching of the voltage is performed by the CPU 21 in the control unit 2 controlling the liquid transportation driving circuit 208d. Switching of the flow direction of the ink as described above is highly effective to maintain the ejection performance of the printing head 10.

That is, if a flow in a certain direction continues, a vortex is generated in the flow of the ink in a curved portion and the like in the flow channel, and the ink stagnates. Aggregates, air bubbles, and the like in the ink are likely to be accumulated in a portion with the stagnation, and if this state continues, the aggregates and air bubbles are increased, and the suppling capacity of the ink and the ejection performance of the liquid droplet may be reduced. To deal with this, in the present embodiment, control to switch the direction of the flow of the ink at a predetermined timing is performed. With this, even if there temporarily occur a vortex and stagnation in a curved portion and the like in the flow channel, the vortex and stagnation are moved and disappear by switching the flow of the ink. As a result, the aggregates and air bubbles do not stay in a fixed position and are discharged in accordance with the flow of the ink. Thus, it is possible to maintain the ejection performance in the printing head 10 for a longer period of time.

### Fourth Embodiment

Next, a fourth embodiment of the present invention is described. In the present embodiment, driving of the pump is controlled such that flows of the ink generated by adjacent pumps have opposite phases to compensate the pulsation of the pressure generated in the common liquid chamber 218. With this, it is possible to reduce a pressure variation in the pressure chamber 203 due to a pressure variation in the common liquid chamber 218, and unevenness of the ejection performance in a macro perspective can be suppressed.

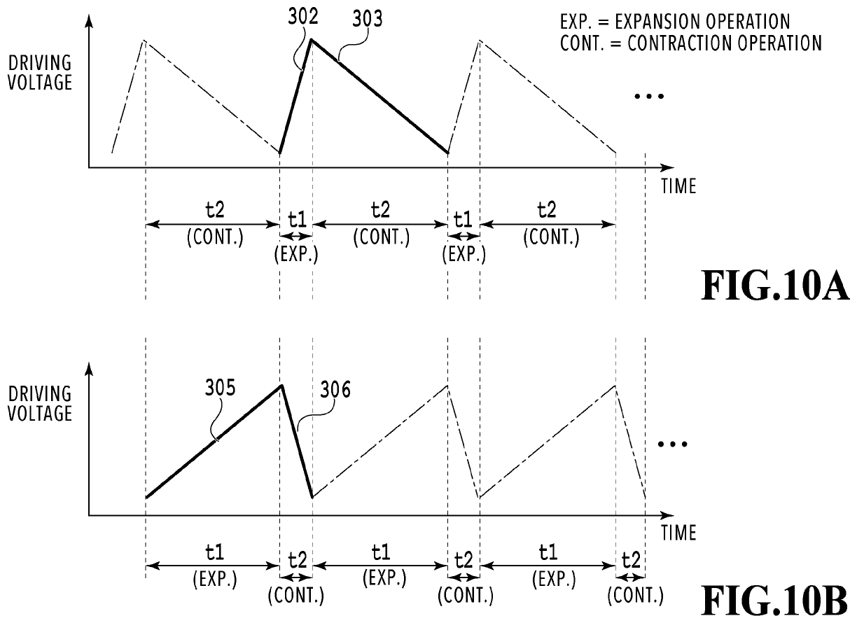

FIGS. 10A and 10B are diagrams illustrating waveforms of the two types of the driving voltages applied to the piezoelectric element 224 of the liquid transportation mechanism 208 in the present embodiment. The driving voltage of the waveform illustrated in FIG. 10A indicates a driving voltage for driving one of adjacent two pumps, and the driving voltage of the waveform illustrated in FIG. 10B indicates a driving voltage for driving the other pump. In a case where the pumps are driven by the driving voltages, the directions of the flows of the ink are directions opposite of each other. In FIGS. 10A and 10B, a pair of driving waveforms that are able to suppress the pulsation in the common liquid chamber 218 are illustrated with a thick solid line.

In FIG. 10A, 302 indicates a voltage waveform (step-up waveform) in the step-up period t1 prompting the rapid expansion operation of the liquid transportation chamber 222. In a case where the pump is driven by the voltage waveform 302, a strong negative pressure is generated in a local portion on the common liquid chamber 218 side. In FIG. 10B, 306 indicates a voltage waveform in the step-down period t2 prompting the rapid contraction operation of the liquid transportation chamber 222. In a case where the pump is driven by the voltage waveform 306 (step-down waveform), a strong positive pressure is generated in a local portion on the common liquid chamber 218 side.

303 illustrated in FIG. 10A indicates a voltage waveform (step-down waveform) in the step-down period t2 prompting the moderate contraction operation of the liquid transportation chamber 222. 305 in FIG. 10B indicates a voltage waveform (step-up waveform) in the step-up period t1 prompting the moderate expansion operation of the liquid transportation chamber 222. Both the voltage waveforms 303 and 305 are voltage waveforms to change the liquid transportation chamber 222 moderately; thus, a pressure propagated to the common liquid chamber 218 with a change in the liquid transportation chamber 222 by those voltage waveforms is small, and an effect on the pressure in the common liquid chamber 218 can be ignored.

The spatial distance between the adjacent pumps is close; thus, the adjacent pumps are driven concurrently by the step-up waveform 302 and the step-down waveform 306 prompting the rapid change in the liquid transportation chamber 222, respectively. In this case, the local pressures generated in the common liquid chamber 218 by the pumps have opposite directions, and thus, in a macro perspective, a pressure distribution in the common liquid chamber 218 can be compensated. As a result, the pulsation generated in the common liquid chamber 218 can be suppressed more than a case of driving the adjacent pumps only by the voltage waveforms of the same phases. As a result, the pressure variation provided to the ink near the ejection port 202 from the common liquid chamber 218 is reduced, and it is possible to stabilize the ejection characteristics.

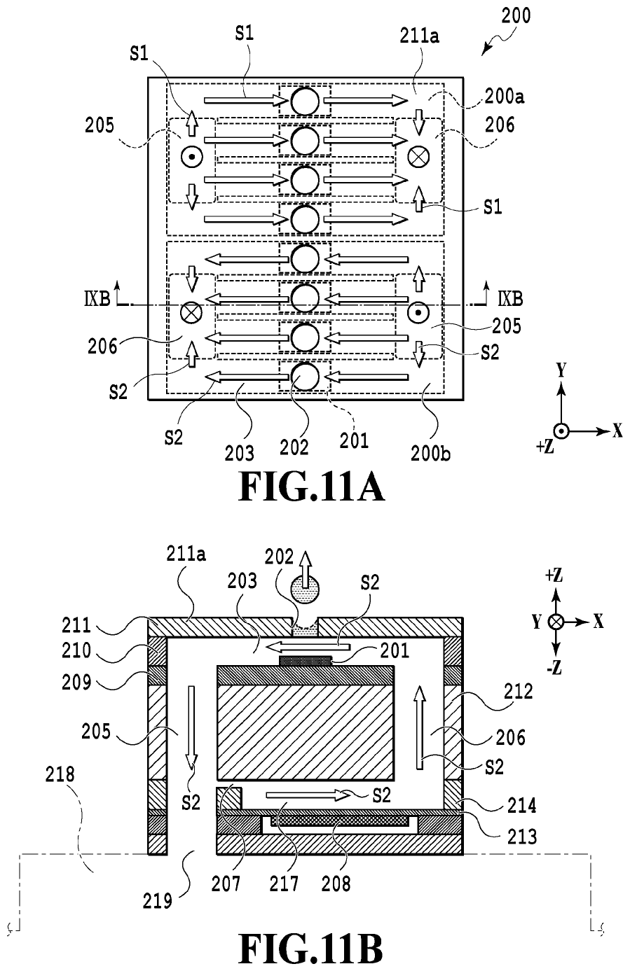

FIGS. 11A and 11B are diagrams illustrating flows of the ink in two regions 200a and 200b provided in one flow channel block 200, while FIG. 11A is a plan view, and FIG. 11B is a cross-sectional view taken along the XIB-XIB line in FIG. 11A. The flow channel block 200 illustrated in FIGS. 11A and 11B has a configuration similar to that illustrated in FIG. 3. Each of the two regions 200a and 200b provided in the flow channel block is provided with the four pressure chambers 203, one supply flow channel 205, and one collection flow channel 206. Additionally, each region is provided with one independent pump including the liquid transportation chamber 222 and the liquid transportation mechanism 208. That is, one flow channel block 200 is provided with two adjacent pumps. The two pumps each serve to flow the ink to the four pressure chambers 203.

One of the two pumps is driven by the driving voltage of the waveform illustrated in FIG. 10A, and the other pump is driven by the driving voltage of the waveform illustrated in FIG. 10B. With this, in the flow channels (the supply flow channel 205 and the collection flow channel 206) of the one region 200a, a flow in the first direction S1 is generated, and in the flow channels (the supply flow channel 205 and the collection flow channel 206) of the other region 200b, a flow in the second direction S2, which is an opposite direction of the first direction, is generated. As a result, the local pressures generated in the common liquid chamber 218 are compensated from each other, and occurrence of the pulsation is suppressed.

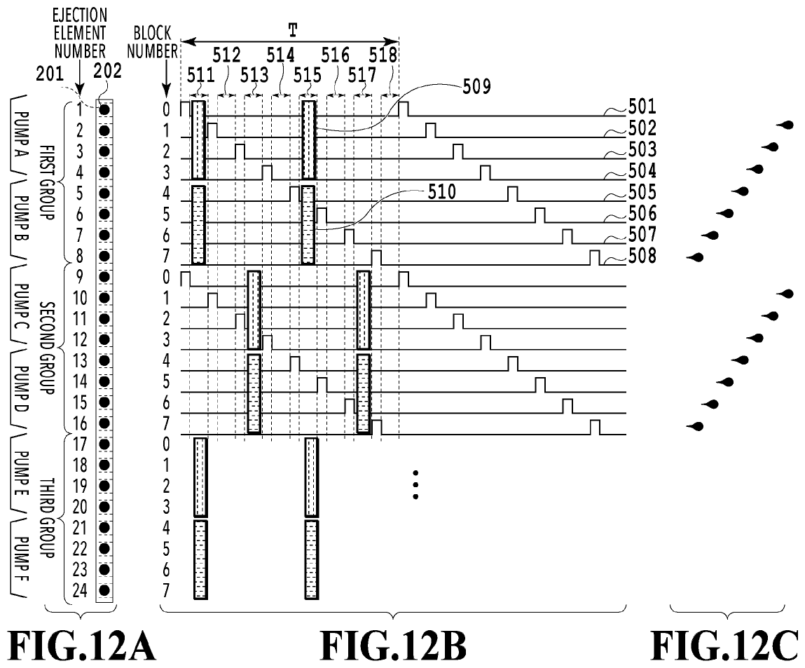

FIGS. 12A to 12C are timing charts illustrating a driving sequence of the ejection elements and the pumps in a case where driving is performed such that flows of the adjacent pumps have opposite phases. The driving timing 509 (vertical broken line) illustrated in FIG. 12B indicates a timing in which the pump is driven by the voltage waveform 302 in FIG. 10A, and the driving timing 510 (horizontal broken line) indicates a timing in which the pump is driven by the voltage waveform 306 illustrated in FIG. 10B. The driving timing 509 and the driving timing 510 are synchronized to each other.

Accordingly, the pumps adjacent to each other in the same group (same flow channel block) perform the rapid liquid transportation operations that generate the rapid inner volume change in the respective liquid transportation chambers 222 in the same driving timing in opposing directions. That is, the pump A and the pump B perform the rapid liquid transportation operation in each of the blanking periods 511 and 515 concurrently in opposing directions, and the pump C and the pump D perform the rapid liquid transportation operation in each of the blanking periods 513 and 517 concurrently in opposing directions. Additionally, the pump E and the pump F perform the rapid liquid transportation operation in each of the blanking period 511 and 515 concurrently in opposing directions.

In the present embodiment, the driving timings of the two pumps in the first group are synchronized but do not coincide with the driving timings of the pumps of the adjacent second group. However, the driving timings of the pumps in the third group in a position away from the first group are synchronized with the driving timings of the pumps in the first group.

With the pumps driven as described above and the ejection characteristics in each ejection unit measured, it was confirmed that a periodic swell, variation, and the like of the ejection characteristics are suppressed. In the present embodiment, the mode in which the two pumps are provided in each group is exemplified; however, the number of the pumps provided in each group is not limited thereto. Note that, in order to make the compensation by performing the rapid liquid transportation operations in the adjacent pumps in the same driving timing in opposing directions as described above, the number of the pumps provided in each group is preferably an even number.

### Fifth Embodiment

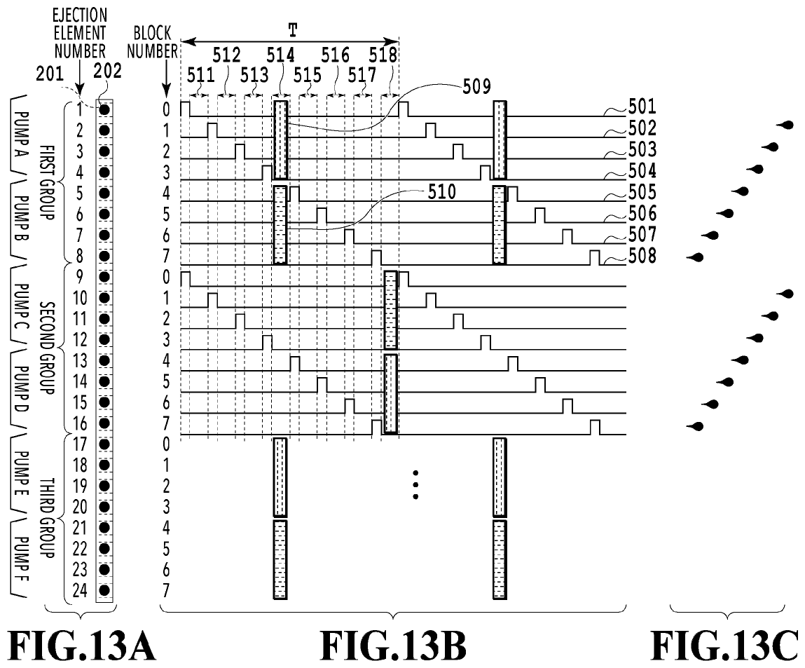

Next, a fifth embodiment of the present invention is described. FIGS. 13A to 13C are timing charts illustrating a driving sequence of the pumps in the fifth embodiment. In the present embodiment, an example in which the pump is driven so as to reduce the liquid transportation amount in the above-described fourth embodiment by half. In the present embodiment, driving of the pump by the voltage waveform 302 illustrated in FIG. 10A is performed in the driving timing 509, and driving of the pump by the voltage waveform 306 illustrated in FIG. 10B is performed in the driving timing 510. Additionally, the driving timing of the pump by the voltage waveform 302 and the driving timing of the pump by the voltage waveform 306 are synchronized. The above points are similar to that in the fourth embodiment.

Note that, in the present embodiment, driving of the pump A is performed after driving of the first to fourth ejection elements ends and before the fifth to eighth ejection elements are driven. Driving of the pump B is performed after driving of the first to fourth ejection elements and before driving of the fifth to eighth ejection elements starts. Thus, in the present embodiment, the rapid liquid transportation operation by the pump is temporally away from the ejection operation of the liquid droplet, and therefore an effect on the ejection performance can be reduced. Additionally, since driving of the pumps is controlled such that the flows of the ink generated by the two pumps in the same group have opposite phases, pressures generated in the pressure chamber 203 can be compensated. With a reduction in the liquid transportation amount by the pump, an effect on the ejection operation due to driving of the pump can be suppressed.

### Sixth Embodiment

Next, a sixth embodiment of the present invention is described. In the above-described embodiments, an example of performing the opposite phase operation to flow the ink in opposite directions in the two pumps corresponding to the same nozzle group is described. In contrast, in the present embodiment, the opposite phase operation to flow the ink in opposite directions is performed between the pumps in nozzle groups adjacent to each other.

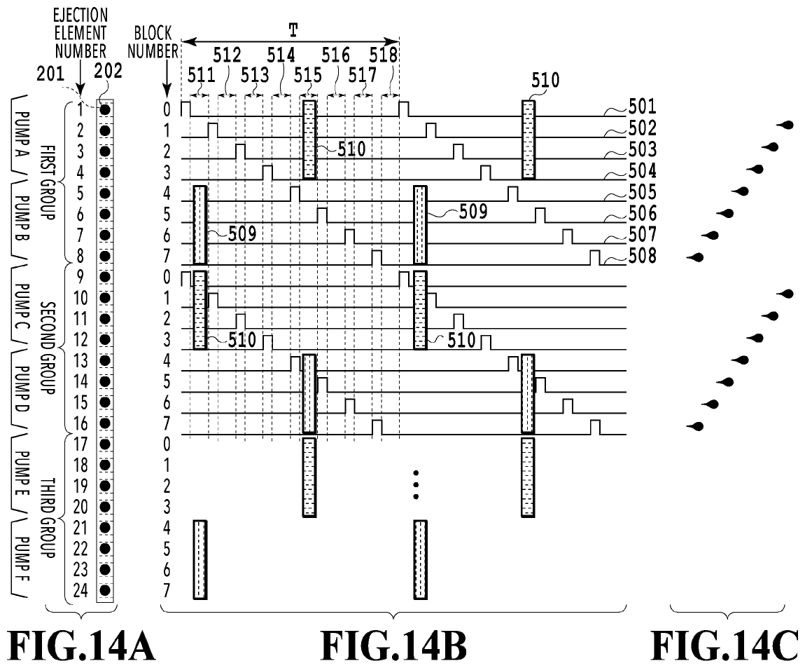

FIGS. 14A to 14C are timing charts illustrating a driving sequence of the pumps in the sixth embodiment. In the example illustrated in FIGS. 14A to 14C, the opposite phase operation is performed by the pump B corresponding to the fifth to eighth ejection elements in the first group and the pump C corresponding to the ninth to twelfth ejection elements in the second group. Additionally, the opposite phase operation is performed by the pump D corresponding to the thirteenth to sixteenth ejection elements in the second group and the pump E corresponding to the seventeenth to twentieth ejection elements in the third group. In the present embodiment, since the opposite phase operation is also performed between the adjacent pumps, it is possible to suppress generation of the pulsation in the common liquid chamber 218.

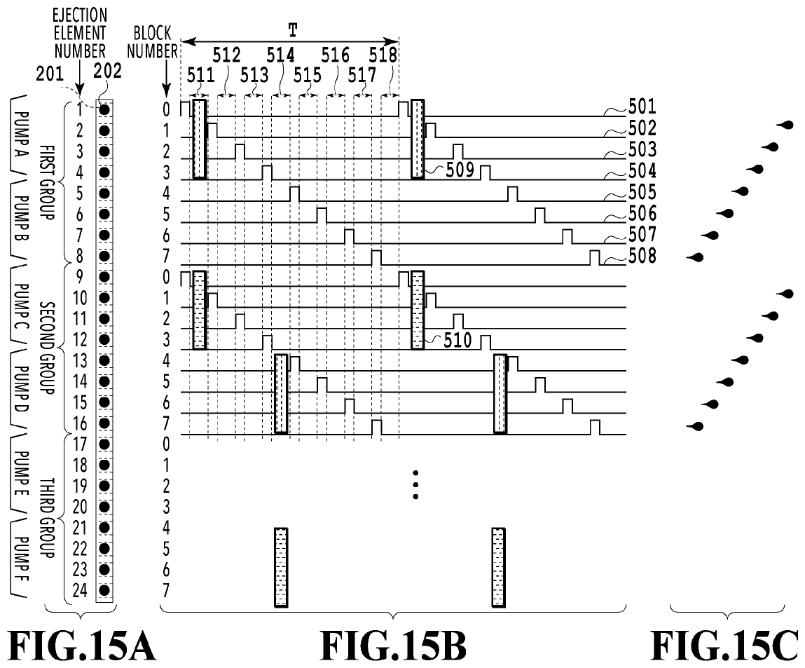

In the example illustrated in FIGS. 15A to 15C, the opposite phase operation is performed by the pump A corresponding to the first to fourth ejection elements in the first group and the pump C corresponding to the ninth to twelfth ejection elements in the second group. Additionally, the opposite phase operation is performed by the pump D corresponding to the thirteenth to sixteenth ejection elements in the second group and the pump F corresponding to the twenty-first to twenty-fourth ejection elements in the third group.

In the present example, the opposite phase operation is performed between the pumps not adjacent to each other; however, it is possible to obtain an effect to suppress the pulsation in the common liquid chamber 218 in this case as well. Regarding routing of a driving wiring and the flow channel structure, it may be difficult to perform the opposite phase operation of pumps adjacent to each other, and the present example is effective in such a case.

### Seventh Embodiment

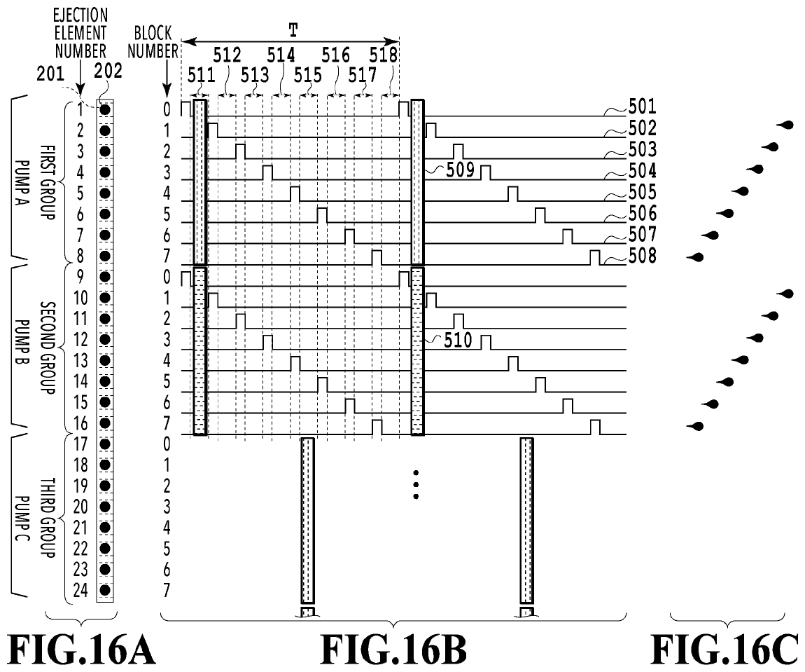

Next, a seventh embodiment of the present invention is described. FIGS. 16A to 16C are timing charts illustrating a driving sequence of the pumps in the seventh embodiment. In the present embodiment, each flow channel block 200 includes the eight ejection elements 201 and pressure chambers 203 and also has a configuration to flow the ink commonly to the eight pressure chambers 203 by one pump. Each flow channel block 200 corresponds to one nozzle group. In FIGS. 16A to 16C, only the first to third nozzle groups are illustrated as with the above-described embodiments.

The opposite phase operation between the adjacent pumps is performed in the present embodiment as well. That is, the opposite phase operation is performed between the pump A corresponding to all the ejection elements in the first group and the pump B corresponding to all the ejection elements in the second group. Additionally, the opposite phase operation is performed between the pump C corresponding to all the ejection elements in the third group and the pump D corresponding to all the ejection elements in the fourth group.

In the present embodiment, a case where the density of the ejection elements is 1200 npi is assumed. In a case where the ejection elements 201 have a high density of about 1200 npi, an area occupied by each flow channel block is small, and an area of about eight nozzles is required to form one pump. In such a case, it is possible to achieve both the ejection operation and the liquid transportation operation of the ink by employing the driving sequence as illustrated in FIGS. 16A to 16C.

In the above embodiments, drying in the ejection unit is likely to progress near an end portion of the ejection port row; thus, the liquid transportation amount by the liquid transportation mechanism 208 may be increased to be relatively greater than that in a portion other than the end portion of the ejection port row (for example, central portion). This increase can be made by increasing an absolute value (rate) of the change amount in the voltage applied to the piezoelectric element of the liquid transportation mechanism 208.

In a case of executing the printing operation, it is possible to grasp in advance the number of times of ejection of the liquid droplet, that is, the number of times of driving of the ejection element 201, based on the printing data; for this reason, it is also possible to relatively increase the liquid transportation amount to the vicinity of the ejection unit in which the number of times of ejection is less.

Additionally, in a case where the ejection unit is positioned outside the printing medium in a serial type printing apparatus that performs printing by relatively moving the printing head 10 with respect to the printing medium, the liquid transportation amount may be increased more than a case where the ejection unit is positioned inside the printing medium. With this, thickening, drying, and the like of the ink caused by the ejection unit positioned outside the printing medium can be suppressed more effectively.

Preliminary ejection to perform ejection that does not contribute printing may be a situation where the ejection unit is positioned outside the printing medium. In the preliminary ejection, in general, more ink is ejected from the ejection port than that in the printing operation period. For this reason, in a preliminary ejection period, more ink needs to be supplied to the ejection port. Thus, in a case where the preliminary ejection is performed, the liquid transportation amount of the ink by the pump is favorably increased to be greater than that in the printing operation period. The liquid transportation amount is increased by increasing the driving amount of the pump. That is, the liquid transportation amount is increased by increasing the number of times of applying the driving voltage to the liquid transportation mechanism 208. In the preliminary ejection, it is unnecessary to take into consideration a landing accuracy of the liquid droplet; for this reason, there is no problem even if a little variation occurs in the pressure near the ejection port due to the increase in the liquid transportation amount of the pump.

As described above, according to the printing apparatus of the embodiments, flowing and circulation of the ink in the printing head 10 can be performed while suppressing an effect on the ejection performance of the ink, and it is possible to maintain the ejection performance in the printing head 10 for a long period of time. The driving sequences of the liquid transportation devices described in the embodiments may be combined with each other.

### OTHER EMBODIMENTS

In the above-described embodiments, the liquid transportation unit that changes the inner volume of the liquid transportation chamber 222 is formed of the liquid transportation mechanism 208 using the piezoelectric element (piezo) that responses substantially linearly to the voltage waveform of the applied driving voltage; however, it is not limited thereto. For example, it is also possible to arrange an energy generation unit such as an electrothermal conversion element (heater) in the liquid transportation chamber to use as the driving source of the liquid transportation. In a case where the electrothermal conversion element is used as the energy generation unit, an electrothermal converter is driven based on the driving signal inputted by the control unit, and heat energy is generated. With this heat energy, film boiling occurs in the liquid (ink), and the liquid in the liquid transportation chamber flows with the bubble generation energy in the film boiling. In this case, the relatively rapid pressure change during bubble generation and the relatively moderate pressure change during bubble disappearance are used to change the inner volume ratio occupied by the air bubbles in the liquid transportation chamber, and thus the liquid transportation operation based on the operations illustrated in FIGS. 4B and 4C can be performed. However, since the rapid pressure change occurs in the ink during bubble generation, the pressure change is likely to be propagated to the vicinity of the ejection port. Thus, in a case where the ejection timing of the liquid and the bubble generation in the liquid transportation operation temporarily coincide with each other, the amount and the direction of the ejected liquid droplet may be varied, and the ejection performance may be reduced.

Accordingly, in a case where the electrothermal conversion element is used, the input timing of the driving signal to control driving of the electrothermal conversion element is controlled by the control unit. That is, the input timing of the driving signal is controlled such that the timing of the bubble generation by the electrothermal conversion element does not coincide with the ejection timing of the liquid. As an example, the input timing of the driving signal may be controlled such that the ejection timing coincides with a bubble disappearance period. Since the pressure of the liquid is changed moderately during the bubble disappearance, if the bubble disappearance period coincides with the ejection timing, it is possible to suppress the reduction in the ejection performance. However, the input timing of the driving signal is not limited thereto. The input timing of the driving signal may be controlled arbitrarily as long as the ejection timing of the liquid and the bubble generation timing do not coincide with each other. As the driving voltage of the electrothermal conversion element, not the driving voltage of an analog waveform like the piezoelectric element but the driving voltage of a pulse waveform is used. Therefore, the driving timing of the electrothermal conversion element can be controlled by controlling the pulse width of the pulse waveform, a combination of multiple pulses, or the like.

According to the present invention, even in a case where an ejection operation of a liquid from an ejection port and a liquid transportation operation to a flow channel communicating with the ejection port are performed in parallel, it is possible to suppress an effect on the ejection operation of the liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-186526 filed Nov. 16, 2021, which is hereby incorporated by reference wherein in its entirety.

What is claimed is:

1. A liquid ejection apparatus, comprising:
a pressure chamber communicating with an ejection port from which a liquid is ejected;
an ejection unit that ejects the liquid stored in the pressure chamber from the ejection port;
a first flow channel that allows the pressure chamber and a liquid supply unit to communicate with each other;
a second flow channel communicating with the pressure chamber;
a connection flow channel communicating with the first flow channel;
a liquid transportation chamber communicating with the connection flow channel and the second flow channel;
a liquid transportation unit that flows the liquid in the liquid transportation chamber in a predetermined direction by expanding and contracting an inner volume of the liquid transportation chamber with application of a driving voltage, which includes a step-up waveform in which the driving voltage rises from an initial voltage to a predetermined reached voltage and a step-down waveform in which the driving voltage drops from the reached voltage to the initial voltage; and
a control unit that controls an ejection operation of the liquid by the ejection unit and an application timing of the driving voltage to the liquid transportation unit, wherein
the control unit controls the application timing of the driving voltage such that a first period, which is a shorter voltage change period out of a voltage change period of the step-up waveform and a voltage change period of the step-down waveform, does not coincide with an ejection timing of the liquid by the ejection unit.

2. The liquid ejection apparatus according to claim 1, wherein
the liquid transportation unit includes a piezoelectric element that is displaced in accordance with an applied voltage.

3. The liquid ejection apparatus according to claim 1, wherein
the driving voltage is a triangle wave including the step-up waveform and the step-down waveform.

4. The liquid ejection apparatus according to claim 1, wherein
with a first driving voltage applied, the liquid transportation unit generates a first circulation flow to circulate the liquid in the order of the first flow channel, the pressure chamber, the second flow channel, the liquid transportation chamber, the connection flow channel, and the first flow channel.

5. The liquid ejection apparatus according to claim 1, wherein
with a second driving voltage applied, the liquid transportation unit generates a second circulation flow to circulate the liquid in the order of the first flow channel, the connection flow channel, the liquid transportation chamber, the second flow channel, the pressure chamber, and the first flow channel.

6. The liquid ejection apparatus according to claim 1, wherein
with a first driving voltage applied, the liquid transportation unit generates a first circulation flow to flow the liquid in the order of the first flow channel, the pressure chamber, the second flow channel, the liquid transportation chamber, the connection flow channel, and the first flow channel, and with a second driving voltage applied, the liquid transportation unit generates a second circulation flow to flow the liquid in the order of the first flow channel, the connection flow channel, the liquid transportation chamber, the second flow channel, the pressure chamber, and the first flow channel, and
out of the first driving voltage and the second driving voltage, the control unit applies one driving voltage to the liquid transportation unit by a predetermined number of times and thereafter applies the other driving voltage to the liquid transportation unit.

7. The liquid ejection apparatus according to claim 6, wherein
either one of the voltage change periods of the step-up waveform and the step-down waveform is the first period of the first driving voltage, and
the other one of the voltage change periods of the step-up waveform and the step-down waveform is the first period of the second driving voltage.

8. The liquid ejection apparatus according to claim 7, wherein
the control unit drives either one of the liquid transportation units adjacent to each other by the first driving voltage and drives the other one by the second driving voltage, and
also synchronizes the first period of the first driving voltage with the first period of the second driving voltage.

9. The liquid ejection apparatus according to claim 1, wherein
an ejection port row is formed of a plurality of the ejection ports,
the ejection unit includes an ejection element row including a plurality of ejection elements provided correspondingly to the plurality of the ejection ports, and
each ejection element generates ejection energy to eject the liquid in the pressure chamber through the corresponding ejection port in accordance with a predetermined ejection signal.

10. The liquid ejection apparatus according to claim 9, wherein
the control unit drives the plurality of the ejection elements with time-division, and
controls the application timing of the driving voltage such that the first period coincides with a pause period between a plurality of the ejection signals to drive the plurality of the ejection elements.

11. The liquid ejection apparatus according to claim 9, wherein
the ejection element row is sectioned into a plurality of groups including a plurality of the ejection elements, and
at least one liquid transportation unit is provided for each of the plurality of groups.

12. The liquid ejection apparatus according to claim 9, wherein
the number of the liquid transportation units driven by the plurality of the driving voltages in which the first periods are synchronized with each other is an even number.

13. The liquid ejection apparatus according to claim 9, wherein
the number of times of driving per unit time the liquid transportation unit corresponding to an end portion of the ejection element row is greater than the number of times of driving per unit time the liquid transportation unit corresponding to an ejection element other than the end portion of the ejection element row.

14. The liquid ejection apparatus according to claim 9, wherein
the control unit controls the number of times of driving per unit time the liquid transportation unit corresponding to the ejection element that performs comparatively less number of times of ejection, out of the ejection element row, to be greater than the number of times of driving per unit time the liquid transportation unit corresponding to the ejection element that performs comparatively more number of times of ejection.

15. The liquid ejection apparatus according to claim 1, wherein
the ejection unit is a printing head capable of performing printing on a printing medium by ejecting ink as the liquid, and
the control unit increases the number of times of driving per unit time the liquid transportation unit in a preliminary ejection period in which the printing head executes preliminary ejection, which does not contribute the printing on the printing medium, to be greater than the number of times of driving per unit time the liquid transportation unit in a printing operation period in which the printing on the printing medium is performed by the printing head.

16. A liquid ejection apparatus comprising:
a pressure chamber communicating with an ejection port from which a liquid is ejected;
an ejection unit that ejects the liquid stored in the pressure chamber from the ejection port;
a first flow channel that allows the pressure chamber and a liquid supply unit to communicate with each other;
a second flow channel communicating with the pressure chamber;
a connection flow channel communicating with the first flow channel;
a liquid transportation chamber communicating with the connection flow channel and the second flow channel;
an energy generation unit that is provided in the pressure chamber and generates energy to flow the liquid stored in the pressure chamber based on an inputted driving signal; and
a control unit that controls an ejection operation of the liquid by the ejection unit and a timing to input the driving signal to the energy generation unit, wherein
the control unit controls the timing to input the driving signal to the energy generation unit so as not to coincide with the ejection operation of the liquid by the ejection unit.

17. A control method of a liquid ejection apparatus, the apparatus comprising:
a pressure chamber communicating with an ejection port from which a liquid is ejected;
an ejection unit that ejects the liquid stored in the pressure chamber from the ejection port;
a first flow channel that allows the pressure chamber and a liquid supply unit to communicate with each other;
a second flow channel communicating with the pressure chamber;
a connection flow channel communicating with the first flow channel;
a liquid transportation chamber communicating with the connection flow channel and the second flow channel, and
a liquid transportation unit that flows the liquid in the liquid transportation chamber in a predetermined direction by expanding and contracting an inner volume of the liquid transportation chamber with application of a driving voltage including a step-up waveform and a step-down waveform, wherein
a timing to apply the driving voltage to the liquid transportation unit is controlled such that an ejection timing of the liquid by the ejection unit does not coincide with a voltage application period in which a voltage waveform out of the step-up waveform and the step-down waveform that has a greater voltage change rate, which is a voltage change amount per unit time, is applied.
